(19) United States
(12) Patent Application Publication
(10) Pub. No.: US 2022/0357204 A1
(43) Pub. Date: Nov. 10, 2022

(54) INTEGRATED SENSOR MODULES FOR DETECTION OF CHEMICAL SUBSTANCES

(71) Applicant: AMS AG, Premstaetten (AU)

(72) Inventors: Frederic Roger, Eindhoven (NL); Troy Chesler, Eindhoven (NL)

(21) Appl. No.: 17/621,440

(22) PCT Filed: Aug. 11, 2020
(86) PCT No.: PCT/EP2020/072526

§ 371 Date: Dec. 21, 2021

Related U.S. Application Data
(60) Provisional application No. 62/885,475, filed on Aug. 12, 2019.

(51) Int. Cl. G01J 3/36; G01N 21/33; G01N 21/31; G01J 3/28

(52) U.S. Cl. CPC G01J 3/36; G01N 21/33; G01N 21/314; G01J 3/2803; G01N 2201/1211; G01N 2021/3155; G01N 2021/3177; G01N 2021/3166

(57) ABSTRACT

An apparatus includes an integrated sensor module for detection of chemical substances. The sensor module includes a UV radiation source operable to emit UV radiation onto a sample. The sensor module also includes a sensor including dedicated channels disposed so as receive UV radiation reflected by the sample. Each of the channels is selectively sensitive to a different respective portion of the UV spectrum; collectively, the channels cover at least part of the UV spectrum sufficient for reconstruction of a spectral curve of the sample. An electronic control unit can be used to identify a composition of the sample based on signals from the channels.

### FIELD OF THE DISCLOSURE

This disclosure relates to integrated sensor modules for the detection of chemical substances.

### BACKGROUND

Various techniques have been proposed for testing chemical substances in laboratory and point-of-care settings. Such tests can be used, for example, for forensic testing of samples to detect the presence of illicit substances (e.g., drugs). The tests can be used, for example, to assist police of other governmental enforcement agencies, as well as by hospitals, harm reduction agencies and patient clinics that care for patients or persons in drug rehabilitation facilities.

The following are examples of techniques that can be used to test for chemical substances: mass spectrometry; infrared spectrometry, Raman spectrometry, x-ray spectrometry, thin-layer chromatography, ultraviolet spectroscopy, spot/color tests, microcrystalline tests, immunoassays and urine dipstick tests. The techniques differ in their ability to discriminate among different substances, in the range of substances that can be detected and discriminated, in their ability to determine the quantity of the particular substance detected, in the relative costs of the tests, and in the ease of using the tests.

In general, it is desirable to provide a low cost integrated sensor that can detect and discriminate among a wide range of chemical substances. Preferably, the sensor should provide increased accuracy and be relatively simple to use.

### SUMMARY

This disclosure describes integrated sensor modules for the detection of chemical substances.

For example, in one aspect, the disclosure describes an apparatus comprising an integrated sensor module for detection of chemical substances. The sensor module includes a UV radiation source operable to emit UV radiation onto a sample, and a sensor including dedicated channels disposed so as receive UV radiation reflected by the sample. Each of the channels is selectively sensitive to a different respective portion of the UV spectrum such that, collectively, the channels cover at least part of the UV spectrum sufficient for reconstruction of a spectral curve of the sample.

The disclosure also describes a method that includes emitting UV radiation toward a sample, and sensing, in at least some of a plurality of dedicated channels, UV radiation reflected by the sample. Each of the channels is selectively sensitive to a different respective portion of the UV spectrum such that, collectively, the channels cover at least part of the UV spectrum sufficient for reconstruction of a spectral curve of the sample. The method includes receiving, in an electronic control unit, output signals from the plurality of channels, and identifying a composition of the sample based on the output signals.

Some implementations include one or more of the following features. For example, in some instances, collectively, the channels cover a continuous part of the UV spectrum. In some cases, the channels are equally distributed over the continuous part of the UV spectrum. The continuous part of the UV spectrum can be, for example, 10 nm-400 nm, 200 nm-400 nm, or some other part of the UV spectrum. In some cases, each of the channels has the same full width half maximum spectral sensitivity (e.g., no more than 10 nm, or no more than 5 nm). In some implementations, each of the channels includes a respective sensing device and a respective UV filter disposed over a UV radiation sensitive portion of the respective sensing device.

The apparatus can include an electronic control unit operable to determine, based at least in part on respective signals from the channels, whether an overall responsivity of the channels aligns with a spectral signature of a particular chemical substance. The electronic control unit can be operable to compare the overall responsivity of the channels to predetermined values stored in memory. In some instances, the electronic control unit is operable to identify a composition of the sample based at least in part on the comparison.

Other aspects, features and advantages will be readily apparent from the following detailed description, the accompanying drawings, and the claims.

### BRIEF DESCRIPTION OF THE DRAWINGS

FIG. 1 illustrates an example of a chemical substance detection sensor module.

FIG. 2 is a block diagram illustrating various functional components of the sensor module.

FIG. 3 is a schematic diagram illustrating an example of a UV sensing device.

FIG. 4 is a flow chart illustrating a method in accordance with the present disclosure.

FIG. 5 is a graph which shows an example of channel transmissions.

FIG. 6 is a graph which shows an example of channel responses from a sample chemical substance.

FIG. 7 is a graph which compares the channel responses to a theoretical stored sample curve.

### DETAILED DESCRIPTION

The present disclosure describes an integrated sensor module operable to detect and discriminate among different chemical substances, such as particulate matter (e.g., molecules of illegal drugs) present in a sample. The sensor module is operable, in some instances, for real-time measurements in which a radiation source emits ultraviolet (UV) radiation toward the sample, and UV radiation reflected by the sample is detected and integrated in an array of spectrally sensitive UV channels.

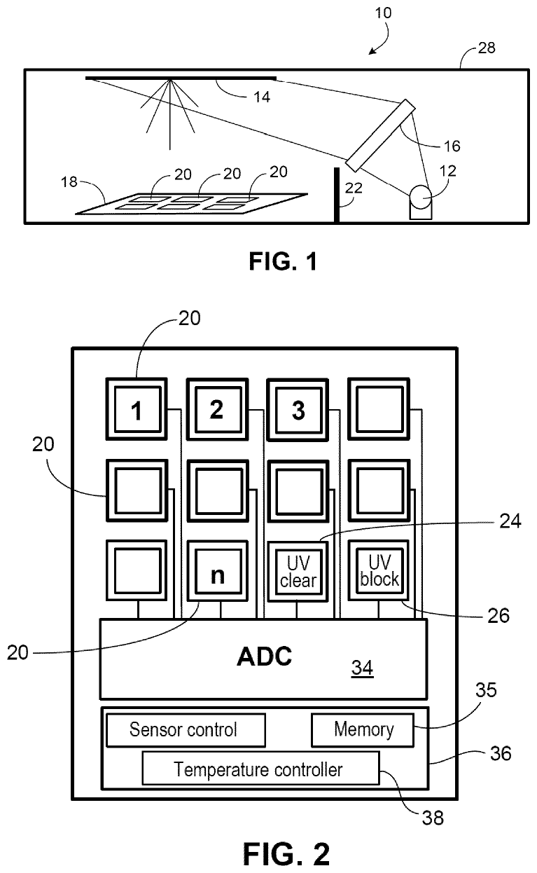

As illustrated in the example of FIG. 1, a chemical substance detection sensor module 10 includes an optical source 12 operable to emit UV radiation toward a sample 14 (e.g., a solid, liquid or gas). The radiation source 12 can include, for example, a tunable monochromatic UV light source operable to emit radiation in the range of about 200-400 nm. In some instances, the radiation source 12 also includes a second switchable broad band radiation source operable to emit longer wavelengths (e.g., up to 900 nm) that can be used to test the fluorescence effect of the sample 14 (i.e., to detect a peak wavelength reflected by the sample). An optical system 16, including one or more lenses or other optical elements, can be provided in the path of the radiation emitted by the source 12 so as to focus the emitted radiation onto the sample 14. As illustrated by FIGS. 1 and 2, at least some of the radiation reflected by the sample can be sensed by a sensor 18 that includes an array of radiation sensitive channels 20.

The array of radiation sensitive channels can include multiple dedicated UV channels each of which is selectively sensitive to a respective narrow window of wavelengths within the UV part of the spectrum such that, collectively, the channels cover the entire UV spectrum (i.e., 10 nm-400 nm) or a particular part of the UV spectrum (e.g., 200 nm-400 nm). Each channel can be sensitive selectively to a respective narrow portion of the UV spectrum centered about a particular wavelength. Preferably, the channels are equally distributed over the entire UV spectrum (i.e., 10 nm-400 nm) or the particular part of the UV spectrum, where the windows for the channels have a substantially uniform width. For example, each channel can have about the same full width half maximum (FWHM) in the range of 1-10 nm (e.g., 5 nm).

Although each channel is selectively sensitive to a respective narrow window within the UV range, the channels collectively can cover an entire continuous portion of the UV spectrum, for example, 200 nm-400 nm, which includes the middle UV (200 nm-300 nm) and near UV (300 nm-400 nm) regions of the spectrum. In some cases, for example, the sensor includes forty channels, each of which is selectively sensitive to a respective range of about 5 nm (FWHM). Preferably, the portion of the UV spectrum within the FWHM of each channel does not overlap (or overlaps only slightly) with the portion of the UV spectrum covered by the other dedicated UV channels. Thus, for example, a first channel may be selectively sensitive to wavelengths in the range of 200-205 nm, a second channel may be selectively sensitive to wavelengths in the range of 205-210 nm, a third channel may be selectively sensitive to wavelengths in the range of 210-215 nm, etc. In this example, the fortieth channel would be selectively sensitive to wavelengths in the range of 395-400 nm. Thus, each respective channel is selectively sensitive to a different narrow range centered about a respective wavelength, where the channels have about the same FWHM as one another and such that, collectively, the channels cover a continuous portion of the UV range. In some implementations, the number of channels, the overall range of the UV spectrum covered collectively by the channels, and/or the FWHM for each channel may differ from the foregoing examples.

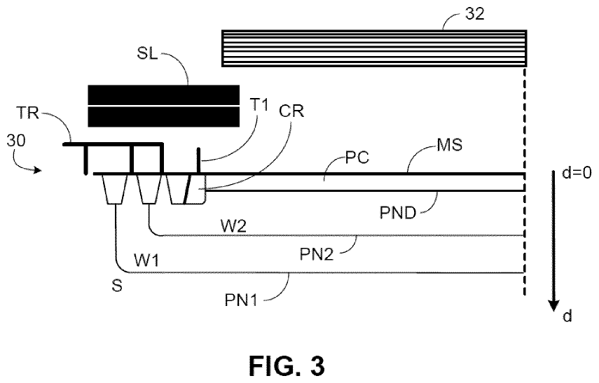

Each channel 20 can incorporate a respective UV sensitive photodiode. In the example illustrated in FIG. 3, each channel 20 contains a dedicated UV sensing device having a UV photodiode structure 30 and a dedicated UV-type filter 32. Preferably, the photodiode structure in each channel 20 has a strong photo-response in the UV part of the spectrum (e.g., 200-400 nm), and has a reduced photo-response in the visible and IR parts of the spectrum.

Each channel also includes an optical filter such as a bandpass filter or UV interference filter having transmission characteristics defined for the particular channel. Thus, for example, a filter for the first channel may selectively pass wavelengths in the range of 200-205 nm, a filter for the second channel may selectively pass wavelengths in the range of 205-210 nm, a filter for the third channel may selectively pass wavelengths in the range of 210-215 nm, etc. In some instances, the photodiode 30 in each particular drug detection channel 20 integrates the sensed UV radiation over time for the various wavelengths within the band as defined by the filter 32 for that channel.

A radiation shield 22 can be disposed between the radiation source 12 and the sensor 18 so as to prevent radiation emitted by the source 12 from directly impinging on the channels 20 of the sensor 18. Preferably, the shield 12 is composed of a material that is non-reflective and non-transmissive for UV radiation. The module 10 can be contained in a dark, non-reflective chamber 28 that isolates the sensor 18 from external parasitic radiation.

As further shown in FIG. 2, in addition to the UV sensitive channels 20, the sensor 18 can include additional channels to help discriminate and measure the UV in-band and out-band radiation. For example, the sensor 18 can include a clear UV channel 24 having a band pass filter that selectively passes, for example, UV radiation in a predetermined range. For example, in some instances, the clear UV channel may selectively pass all wavelengths (e.g., 200-400 nm) covered by the narrow UV sensitive channels 20. Thus, the UV clear channel 24 is operable to measure the overall UV response of the sample 14 within the predetermined UV range. Further, the sensor 18 can include a UV block channel 26, which passes non-UV radiation (e.g., visible light and infrared (IR) radiation), but blocks UV radiation. The UV block channel 26 allows the module 10 to measure the out of band radiation seen by the sample 14.

Various chemical substances (e.g., drugs) inherently have unique spectral responses to the UV light source 12. The output signals from the channels 20 can be used by the sensor module 10 to discern the type of drug or other chemical substance present in the sample 14.

As further illustrated in the example of FIG. 2, the sensor module 10 can include an analog-to-digital converter (ADC) 34 to measure the photocurrent generated by the photodiode 30 in each channel 20, 24, 26. The output responses then are transmitted to signal processing circuitry 36 for signal treatment and data analysis so as to identify whether any of one or more predetermined chemical substances are present in the sample 14, as well as the quantity of each chemical substance. The signal processing circuitry 36 is operable to identify the chemical substance(s) in the sample 14 based on an analysis of the output signals from the channels 20. In some instances, the sensor 18 can integrate signals in the UV channels 20 in parallel (i.e., simultaneously) and can perform signal processing to discern responsivities that match or align with a particular spectral signature of a drug or other chemical substance. The spectral signatures for one or more chemical substances can be stored, for example, in memory 35. By comparing the combined output signals for the channels 20 to the spectral signatures stored in memory 35, the signal processing circuitry 36 can determine whether there is a match between the chemical substance of the sample 14 and the spectral signature associated with signals from the channels 20 and, if so, to identify the chemical substance detected. In some instances, the signal processing circuitry 36 also can determine the quantity of the chemical substance detected.

Signals generated by the UV clear channel 24 and the UV block channel 26 can serve, for example, as reference signals. For example, a signal from the UV block channel 26 can be processed and used by the signal processing circuitry 36 to normalize the signals obtained from the UV channels 20. Likewise, a signal from the UV clear channel 24 can be processed and used by the signal processing circuitry 36 to improve signal/noise ratio. Signals from the UV clear and UV block channels 24, 26 also can be used to improve the overall signal acquisition process by detecting and accounting for background radiation.

In some implementations, the module 10 includes an on-die temperature sensor coupled to a temperature controller 38 to provide temperature-dependent leakage current compensation of the UV photodiode 30 in each channel 20. Incorporating the temperature controller 38 can aid in temperature-drift offset correction from the front-end ADC 34 resulting from photodiode leakage and general transistor leakage from the analog front-end. The temperature controller 38 also can be incorporated as part of the signal processing circuitry 36.

The signal processing circuitry 36 can be implemented, for example, as an electronic control unit (ECU). In some cases, the processing circuitry 36 may include software and/or firmware. An output of the signal processing circuitry 36 can be coupled, for example, to a monitor or other display unit to indicate whether there is a match between the chemical substance of the sample 14 and the spectral signature associated with any one of the channels 20 and, if so, to identify the chemical substance detected, as well as the quantity detected.

In some implementations, a photodiode structure 30 suitable for use in the channels 20 of the sensor 18 includes a superposition of two wells, in particular two ion-implanted wells, with opposite types of electrical conductivity within a semiconductor substrate. The semiconductor substrate has a first type of electrical conductivity, whereas a first well has a second type, and a second well has the first type. By adjusting doping concentrations or profiles of the wells, a photon capturing layer having the second type of electrical conductivity is formed at a main surface of the semiconductor substrate. A p-n junction formed between the photon capturing layer and the second well is usable for detecting incident UV radiation. The photodiode structure 30 can be implemented, for example, in a semiconductor wafer or a semiconductor die and/or can be part of an integrated circuit.

As shown in the example of FIG. 3, the UV photodiode structure 30 includes a semiconductor substrate S including a semiconductor material, for example silicon, and having a first type of electrical conductivity, for example p-type conductivity. The photodiode structure further includes a first well W1 arranged within the semiconductor substrate S and having a second type of electrical conductivity opposite to the first type, the second type being, for example, n-type conductivity. The photodiode structure 30 further includes a second well W2 arranged, for example, within the first well W1 and having the first type of electrical conductivity. Consequently, a first p-n junction PN1 is formed by a boundary between the semiconductor substrate S and the first well W1, and a second p-n junction PN2 is formed by a boundary between the first well W1 and the second well W2. Advantageously, such a photodiode structure is predominantly sensitive to UV radiation, and the sensitivity to visible light or infrared radiation is reduced.

Within a surface region at a main surface MS of the semiconductor substrate S, a doping concentration, in particular a carrier concentration, of the first well W1 is greater than a doping concentration, in particular a carrier concentration, of the second well W2. Therefore, a photon capturing layer PC having the second type of electrical conductivity is formed at the main surface MS, in particular in the surface region. Thus, a detection p-n junction PND is formed by a boundary between the second well W2 and the photon capturing layer PC. In this example, a part of the second well W2 not corresponding to the photon capturing layer PC is denoted as the second well W2, and a part of the first well W1 corresponding neither to the second well W2 nor to the photon capturing layer PC is denoted as the first well W1.

In the example of FIG. 3, the photodiode structure 30 includes a contact region CR having the second type of electrical conductivity within the semiconductor substrate for contacting the photon capturing layer PC. The photodiode structure 30 further includes a first sense terminal T1 connected to the photon capturing layer PC, for example, via the contact region CR. Furthermore, the photodiode structure 30 can include a reference terminal TR connected to the semiconductor substrate S, the first well W1 and second well W2. In some implementations, the reference terminal TR is connected to the semiconductor substrate S and the first well W1, and the photodiode device includes a further reference terminal connected to the second well W2.

A photodiode structure 30 of the sensor device of FIG. 3 is formed by the first and the second wells W1, W2 and the resulting photon capturing layer PC. In particular, the detection p-n junction PND can be used to detect UV radiation. A photocurrent generated within the depletion region of the detection p-n junction PND can, for example, be read out or measured via the first sense terminal T1.

In some implementations, other structures can be used for the UV radiation sensing device in each channel of the sensor 18.

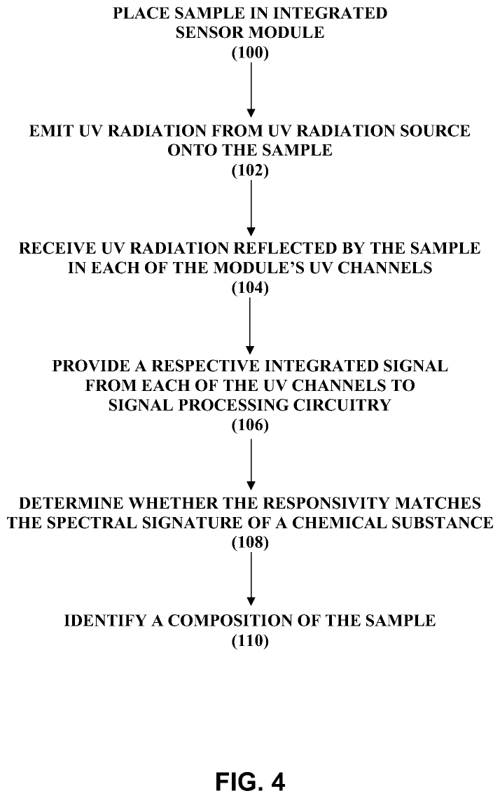

FIG. 4 illustrates a method in accordance with the present disclosure. The method includes placing a sample 14 in an integrated sensor module operable for detection of chemical substances (100), and emitting UV radiation from the UV radiation source 12 onto the sample (102). The method further includes receiving UV radiation reflected by the sample in each of the module's UV channels 20 (104), where the channels include respective filters 32 over radiation sensitive regions of the sensor 18 as described above. In some instances, the method includes integrating signals in each of the UV channels in parallel. The method includes providing a respective integrated signal from each of the UV channels to the signal processing circuitry 36 (106), and determining, based at least in part on the respective integrated signals from the UV channels, whether the responsivity matches or aligns with the spectral signature of a chemical substance (108). Determining whether a respective responsivity matches or aligns with the spectral signature of a particular chemical substance can include, for example, comparing the combination of signals from the UV channels to predetermined values stored in memory 35. In some instances, the method includes identifying a composition of the sample based at least in part on the comparison (110).

As noted above, the channels 20 can be operable collectively to detect radiation over the entirety of the UV range or at least over a continuous portion of the UV range (e.g., 200 nm-400 nm). Thus, by storing in memory 25 the spectral signatures for many different chemical substances, the sample 14 can be tested with respect to a relatively wide range of chemical substances.

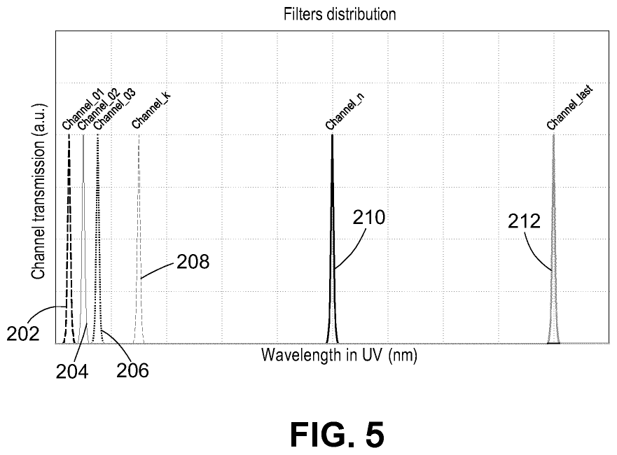

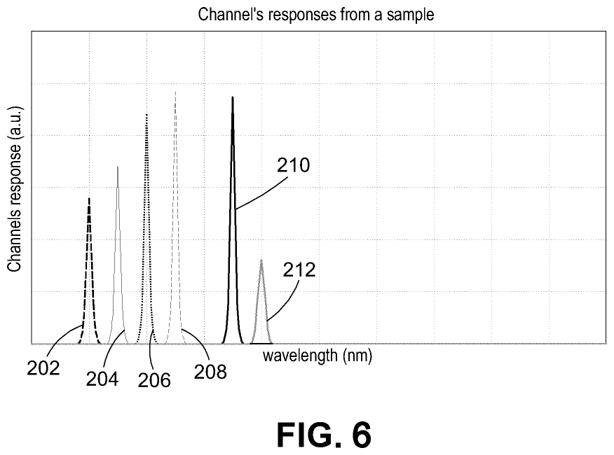

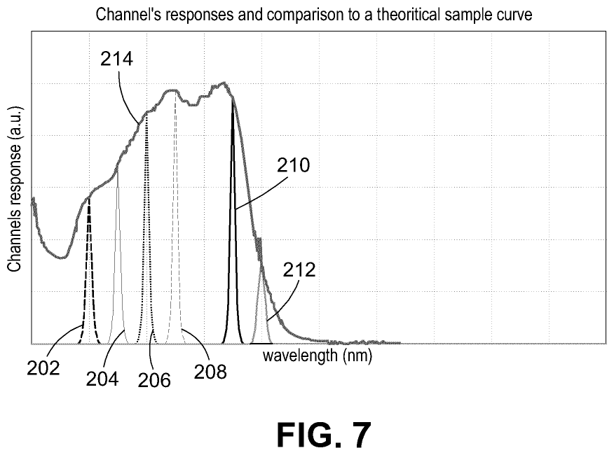

Although in many instances it will be advantageous for the channels 20 to be operable collectively to detect radiation over the entirety of the UV range or at least over a continuous portion of the UV range, in some implementations it is not necessary to the coverage of the channels to be continuous. Rather, more generally, there should be enough channels with sufficient bandwidth in the UV range to reconstruct the spectral curve of the sample 14. An example is illustrated in FIG. 5, which shows multiple narrow bandwidth channels 202 (channel_01), 204 (channel_02), 206 (channel_3), . . . 208 (channel_k) . . . 210 (channel_n) . . . 212 (channel_last). FIG. 6 illustrates a conceptual example of the channel responses for a particular sample 14, where the responses are normalized with respect to the responsivity of the detector material (e.g., silicon). FIG. 7 shows an example of the channel responses and a comparison to a theoretical sample curve 214. A comparison of the reconstructed spectral curve to sample curves stored in a database facilitates matching the spectral response to a particular chemical substance as well as providing information indicative of the quantity of the chemical substance in the sample 14.

Various aspects of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Various modifications can be made within the spirit of the present disclosure. Thus, other implementations are within the scope of the claims.

1. An apparatus comprising an integrated sensor module for detection of chemical substances, the sensor module including:
a UV radiation source operable to emit UV radiation onto a sample; and
a sensor including a plurality of dedicated channels disposed so as receive UV radiation reflected by the sample, wherein each of the channels is selectively sensitive to a different respective portion of the UV spectrum and wherein, collectively, the channels cover at least part of the UV spectrum sufficient for reconstruction of a spectral curve of the sample.

2. The apparatus of claim 1 wherein collectively, the channels cover a continuous part of the UV spectrum.

3. The apparatus of claim 2 wherein the channels are equally distributed over the continuous part of the UV spectrum.

4. The apparatus of claim 2 wherein the continuous part of the UV spectrum is 10 nm-400 nm.

5. The apparatus of claim 2 wherein the continuous part of the UV spectrum is 200 nm-400 nm.

6. The apparatus of claim 2 wherein each of the channels has the same full width half maximum spectral sensitivity.

7. The apparatus of claim 6 wherein the full width half maximum is no more than 10 nm.

8. The apparatus of claim 6 wherein the full width half maximum is no more than 5 nm.

9. The apparatus of claim 1 wherein each of the channels includes a respective sensing device and a respective UV filter disposed over a UV radiation sensitive portion of the respective sensing device.

10. The apparatus of claim 1 further including an electronic control unit operable to determine, based at least in part on respective signals from the channels, whether an overall responsivity of the channels aligns with a spectral signature of a particular chemical substance.

11. The apparatus of claim 10 wherein the electronic control unit operable to compare the overall responsivity of the channels to predetermined values stored in memory.

12. The apparatus of claim 11 wherein the electronic control unit operable to identify a composition of the sample based at least in part on the comparison.

13. A method comprising:
emitting UV radiation toward a sample;
sensing, in at least some of a plurality of dedicated channels, UV radiation reflected by the sample, wherein each of the channels is selectively sensitive to a different respective portion of the UV spectrum and wherein, collectively, the channels cover at least part of the UV spectrum sufficient for reconstruction of a spectral curve of the sample;
receiving, in an electronic control unit, output signals from the plurality of channels; and
identifying a composition of the sample based on the output signals.

14. The method of claim 13 wherein collectively, the channels cover a continuous part of the UV spectrum.

15. The method of claim 14 wherein the channels are equally distributed over the continuous part of the UV spectrum.

16. The method of claim 14 wherein the continuous part of the UV spectrum is 10 nm-400 nm, or wherein the continuous part of the UV spectrum is 200 nm-400 nm.

17. (canceled)

18. The method of claim 13 wherein each of the channels has the same full width half maximum spectral sensitivity.

19. The method of claim 18 wherein the full width half maximum is no more than 10 nm or wherein the full width half maximum is no more than 5 nm.

20. (canceled)

21. The method of claim 13 wherein identifying the composition includes determining whether an overall responsivity of the channels aligns with a spectral signature of a particular chemical substance.

22. The method of claim 21 wherein identifying the composition includes comparing the overall responsivity of the channels to predetermined values stored in memory.
